(19) United States
(12) Patent Application Publication
(10) Pub. No.: US 2016/0341209 A1
(43) Pub. Date: Nov. 24, 2016

(54) METHOD AND SYSTEM FOR SUPPLYING BARRIER FLUID IN A SUBSEA MOTOR AND PUMP ASSEMBLY

(71) Applicant: VETCO GRAY SCANDINAVIA AS, Sandvika (NO)

(72) Inventors: Giacomo LANDI, Oslo (NO); Jorgen WESSEL, Asker (NO); Lorenzo BERGAMINI, Bari (IT); Terje GLOMSAKER, Bekkestua (NO); Hans Kristian SUNDT, Oslo (NO); Sudhir CHAMBHARE, Oslo (NO)

(21) Appl. No.: 15/107,497

(22) PCT Filed: Nov. 11, 2014
(86) PCT No.: PCT/IB2014/002410

§ 371 Date: Jun. 23, 2016

(30) Foreign Application Priority Data
Dec. 23, 2013 (NO) 20131745

(51) Int. Cl. F04D 29/10; B01D 61/02; C02F 1/44; F04D 13/08; F04D 29/18

(52) U.S. Cl. CPC F04D 29/108; F04D 13/086; F04D 29/18; C02F 1/441; B01D 61/025; C02F 2103/08

(57) ABSTRACT

A method for supplying barrier fluid in a subsea motor and pump assembly is disclosed, wherein desalinated water is extracted from or downstream of a reverse osmosis device and supplied to the motor and pump assembly, alone or as mixture with ethylene glycol. A corresponding system is likewise disclosed.

### TECHNICAL FIELD

Embodiments of the present invention relate to a method for supplying barrier fluid in a subsea motor and pump assembly. The embodiments of the present invention analogously refer to a system configured for implementation of the method.

### BACKGROUND

In the process of subsea hydrocarbon production, seawater is used in the process for several purposes, one of which may be injection of water into hydrocarbon deposits as substitute for recovered hydrocarbon fluid, or to assist the extraction of hydrocarbon products by raising the pressure in the hydrocarbon containing formations, e.g.

Pumps and motors used subsea to produce water at adequate flow and pressure for the process usually include a motor in a motor compartment drivingly connected to a pump rotor in a pump housing. The motor and pump assembly requires efficient motor cooling and lubrication of seals and bearings for rotating parts. A motor seal and a pump seal is typically arranged sealing about a common shaft between motor and pump rotor, the pump and motor seals axially separated on the shaft. The motor seal and the pump seal define between them a barrier fluid chamber which is separated from motor coolant/lubrication fluid on the remote side of the motor seal, and separated from pumped medium on the remote side of the pump seal. Oil used as motor coolant, lubrication and barrier fluid is usually supplied under pressure from topside to the motor compartment and the barrier fluid chamber. The pressures in the motor compartment and the barrier fluid chamber are set to prevent pumped medium from bleeding through the seals into the motor compartment, where salts and other particulates in the pumped medium would damage bearings and rotating parts. On the contrary, the pressures in the motor compartment and barrier fluid chamber are dimensioned to cause migration or leakage of fluid from the motor compartment, seals and barrier fluid chamber into the pumped medium.

The procedure is however unsuitable in implementations wherein fluid containing hydrocarbons must not contaminate the pumped medium, such as when the pumped medium is seawater which is used in the process further downstream of the pump.

### BRIEF DESCRIPTION

In an embodiment of the present invention, a method and a system for supplying barrier fluid to a subsea motor and pump assembly is provided.

In another embodiment of the present invention, a method and a system for supplying treated water as subsea barrier fluid to a seawater injection system is provided.

In a further embodiment of the present invention, a method and a system for avoiding leakage of motor cooling fluid or lubrication fluid or barrier fluid into the pumped medium in a subsea motor and pump assembly which is operated to produce process water from seawater is provided.

These embodiments are disclosed in a method for supplying barrier fluid in a subsea motor and pump assembly, wherein desalinated water is extracted from or downstream of a reverse osmosis device and supplied to the motor and pump assembly, alone or as mixture with ethylene glycol.

In one embodiment the method includes providing a volume of glycol in a glycol tank arranged subsea, desalination of seawater by passing seawater through a reverse osmosis device arranged subsea, mixing glycol with desalinated seawater, and feeding the water/glycol mixture as barrier/lubrication fluid to the motor/pump assembly.

In one embodiment the method includes feeding the discharge pressure from the reverse osmosis device to a membrane installed in the glycol tank to set the pressure in glycol equal to the discharge pressure from the reverse osmosis device.

One embodiment of the method includes regulating the discharge pressure from the reverse osmosis device to in the order of approximately 10-30 bar, more particularly, approximately 20 bar, above the pump pressure.

One embodiment of the method includes mixing water with glycol in a three way valve and feeding the mixed fluid to an expansion tank.

Embodiments of the method include monitoring of the inlet pressure to the pump and setting the pressure in the expansion tank to in the order of approximately 10-30 bar, more particularly, approximately 25 bar, above the pump inlet pressure.

Embodiments of the method include mixing water with glycol to a ratio of water to glycol in the order of 40-60%.

In a subsea motor and pump assembly arranged for producing process water from seawater, wherein a motor in a motor compartment is drivingly connected to a pump rotor in a pump housing, a shaft between them transmitting the motion of the motor to the pump rotor, the method includes operating the pump for boosting the pressure in seawater discharged from the pump, passing the seawater through a reverse osmosis device for desalination, extracting desalinated water from the reverse osmosis device or from a process water flow downstream of the reverse osmosis device, raising the pressure in the extracted water to above the internal pressure in the pump, and feeding the pressurized extraction water to the motor/pump assembly for cooling and/or lubrication and/or barrier purposes.

Embodiments of the invention include feeding the extraction water into a barrier fluid chamber arranged and defined between a motor seal, separating the extraction water from lubricant fluid, and a pump seal separating the extraction water from seawater in the pump.

In some embodiments the extraction water is returned from the barrier fluid chamber for re-injection into the seawater downstream of the reverse osmosis device. The barrier fluid chamber is in this way flushed with desalinated seawater extracted from the produced water flow downstream of the pump.

Extracted desalinated water may additionally be supplied to a pump shaft bearing in the non-driven end of the pump. In one embodiment the extraction water is injected between dual seals defining a barrier fluid chamber that separates the seawater in the pump from lubricant supplied to the pump shaft bearing. In another embodiment the extraction water is flushed through the pump shaft bearing for lubrication. In both cases extraction water may be allowed to migrate into the raw seawater in the pump.

The method includes raising the pressure in the extracted water to a pressure higher than the internal pressure of the pump. This can be accomplished by means of a pump and a pressure regulator which can be set to deliver a pressure related to a pilot pressure in combination with a pressure sensor. In one embodiment the pressure in the extracted water is raised to at least about 20 bar above the pressure in the seawater discharged from the pump.

Embodiments of the method include mixing the extracted water with glycol (ethylene glycol C₂H₄(OH)₂) before feeding to the motor/pump assembly.

The pressure in the water/glycol mixture is raised to exceed the fluid pressure in a barrier fluid chamber, the water/glycol mixture is allowed to migrate into the barrier fluid chamber via the motor seal. The pressure in the water/glycol mixture may be set to at least about 20 bar above the pressure in the seawater discharged from the pump.

The objects of the present invention are further met by a system including a subsea motor and pump assembly arranged in a seawater flow for boosting the pressure in seawater which is passed through a reverse osmosis device for desalination. Desalinated water is extracted from or downstream of the reverse osmosis device and communicated to the motor/pump assembly via a feed line and pump or accumulator that raises the pressure in the extracted water to above the internal pressure in the pump.

More precisely, a motor in a motor compartment is drivingly connected to a pump rotor in a pump housing, a shaft transmitting the motion of the motor to the pump rotor. The motor and pump assembly further includes a motor seal and a pump seal sealing about the shaft, the pump and motor seals axially separated on the shaft. The motor seal and the pump seal defines between them a barrier fluid chamber which is separated from motor coolant/lubrication fluid on the remote side of the motor seal, and separated from seawater on the remote side of the pump seal.

A barrier fluid feed line connecting the barrier fluid chamber with the reverse osmosis device, or with the process water flow downstream of the reverse osmosis device, provides supply of desalinated seawater for injection into the barrier fluid chamber via the reverse osmosis device and a pressure regulator.

A barrier fluid return line connecting the barrier fluid chamber with the process water flow downstream of the reverse osmosis device can be arranged for routing water from the barrier fluid chamber to the process water flow downstream of the point of extraction.

A pump shaft bearing in the non-driven end of the pump may be arranged in flow communication with the extraction water feed line for supply of desalinated water for cooling or lubrication purpose, or otherwise to act as a barrier between seawater in the pump and other cooling or lubrication fluid supplied to the bearing in the non-driven end of the pump.

In one embodiment, the system includes a subsea tank holding a volume of glycol, a reverse osmosis device arranged subsea, a three way valve controllable for mixing desalinated water from the reverse osmosis device with glycol from the glycol tank, and feed lines to supply the water/glycol mixture as barrier/lubrication fluid to the motor/pump assembly.

One embodiment of the system includes a membrane setting the pressure in glycol in the glycol tank, wherein the membrane is subjected to the discharge pressure from the reverse osmosis device.

In one embodiment a pressure regulation valve is installed to set the discharge pressure from the reverse osmosis device to about 20 bar above the pump pressure.

In one embodiment an expansion tank is installed to receive the water/glycol mixture from the three way valve.

In embodiments of the system the pressure in the expansion tank is set to about 25 bar above the pump pressure which is detected through a pressure control valve arranged at the inlet to the pump.

Further details of the embodiments will appear from the following description of disclosed embodiments of the invention.

### BRIEF DESCRIPTION OF THE DRAWINGS

Embodiments of the invention will be explained below with reference made to the accompanying, schematic drawings wherein

FIG. 1 is a simplified schematic overview of the components and their internal relation in a subsea motor and pump assembly arranged for producing process water from seawater,

FIG. 2 is a view corresponding to FIG. 1, showing an embodiment of the present invention implemented in a seawater injection system,

FIG. 3 illustrates the motor and pump assembly on a more detailed scale,

FIG. 4 is a cut out portion showing a detail of the motor and pump assembly of FIG. 3 on a larger scale, and

FIG. 5 shows an alternative implementation of the present invention.

### DETAILED DESCRIPTION

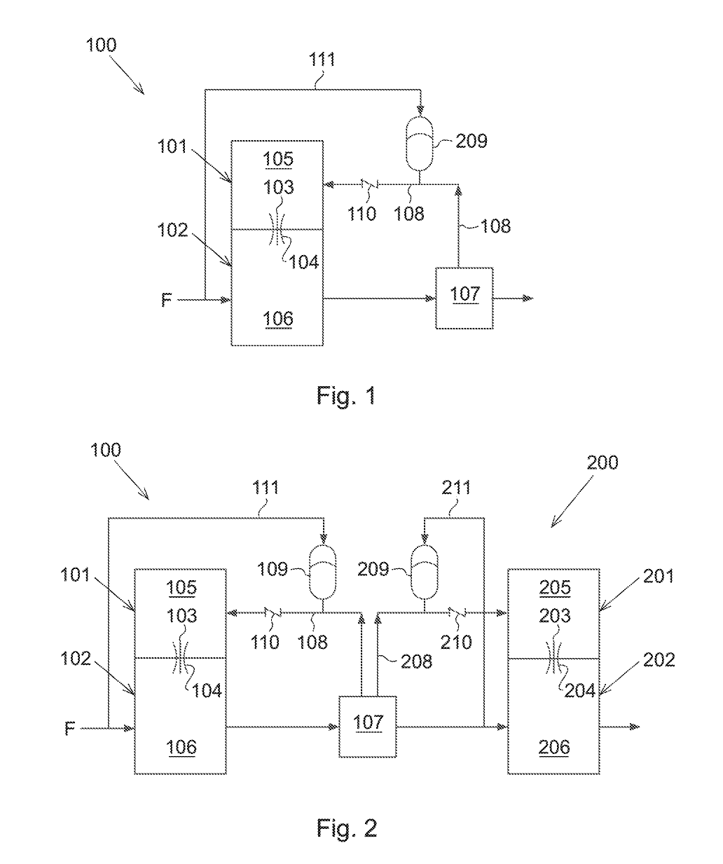

A motor and pump assembly is schematically illustrated in FIG. 1 and generally defined by reference number 100. The motor and pump assembly 100 includes a motor 101 and a pump 102. The motor is drivingly connected to the pump via a shaft that passes from a motor compartment into a pump chamber via a seal arrangement. In FIG. 1 the drive shaft is represented by a straight line 103, whereas the seal arrangement is represented by the curved lines 104, illustrating a restriction about the shaft. The motor compartment is defined by reference number 105 and the pump chamber is denoted 106.

The pump is installed in a seawater flow F and operated for boosting the pressure in seawater that passes through the pump. The seawater that is discharged from the pump at an elevated pressure is supplied to a reverse osmosis device 107 in which the seawater is forced through a membrane for desalination. Desalinated water is discharge from the reverse osmosis device as process water for further use downstream. Desalinated water is extracted from the reverse osmosis device and supplied as barrier fluid to the motor via an extraction water feed line 108. The pressure of the extraction water is raised by means of a pressure regulator and a pump or a pressure vessel/accumulator 109 which provides a fixed overpressure across the seal 104. A non-return valve or check valve 110 maintains a unified directional flow of desalinated extraction water to the motor.

The accumulator provides a storage of pressurized desalinated water for motor in transient operations. The accumulator is pre-pressurized to the required overpressure across the seal between the motor and pump. Additional real-time pressure can be applied from the pump suction pressure as indicated by line 111, such that the accumulator can provide the combined pressures.

The seawater injection system of FIG. 2 incorporates the components of the motor and pump assembly 100 of FIG. 1. In the seawater injection system 200 the desalinated water that is discharged from the reverse osmosis device 107 is supplied to the inlet of a water injection pump 202. The pump 200 is driven by a motor 201 via a shaft 203 that passes a seal arrangement 204 between a motor compartment 205 and a pump chamber 206. Desalinated water is extracted via extraction water feed line 208 and supplied as barrier fluid to the motor via the check valve 210. Accumulator 209 supplies the overpressure required relative to the pressure in the pump. Pump inlet pressure is transferred to the accumulator via line 211.

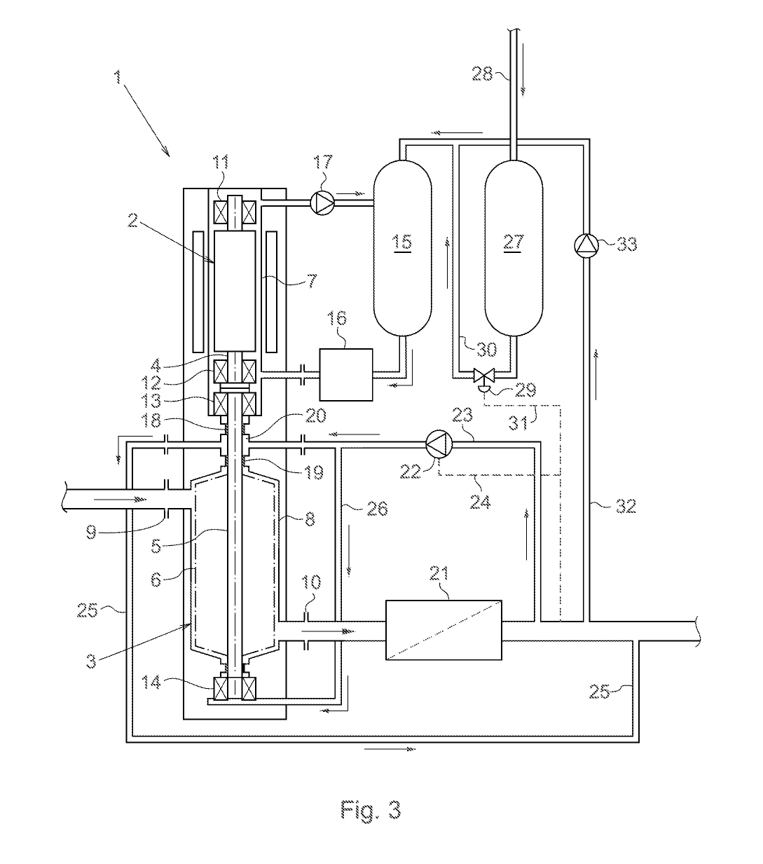

In the drawing of FIG. 3 a subsea motor and pump assembly 1 is shown schematically, including a motor 2 and a pump 3. The motor and pump are arranged in axial alignment, the motor 2 via a drive shaft 4 drivingly connected with a pump rotor shaft 5 of a pump rotor 6, the latter only indicated through dash-dot lines. Rotating parts of the motor 2, such as rotor and rotor windings of an electrical motor 2, are supported in a motor compartment 7. Rotating parts of the pump 3, i.e. the pump rotor and the pump rotor shaft, are supported in a pump chamber 8 including an inlet 9 and an outlet 10 for a pumped medium, in this case seawater.

The drive shaft 4 and the pump rotor shaft 5 are journaled in bearings designed to take up radial and thrust loads, in the drawing schematically illustrated by bearing symbols 11, 12, 13 and 14. The bearings 11-14 may be realized as mechanical bearings or as non-contact magnetic bearings, e.g.

Fluid for cooling and/or lubrication purposes, in this disclosure sometimes commonly referred to as lubricant, is introduced in the motor compartment and bearings from a pressure vessel 15 containing the lubricant under pressure. The pressure vessel 15 may be included in a circulation loop including lubricant supply and return flow lines, and if appropriate a cooler 16 and a circulation pump 17.

In order to prevent leakage of lubricant from the motor compartment into the pump housing and the pumped medium/seawater, dual seals 18 and 19 are arranged to seal about the drive shaft or about the pump rotor shaft, respectively. The seals 18, 19 are arranged with internal spacing along the shaft. The seals 18, 19 provide between them a barrier fluid chamber 20 which is defined between a motor seal 18, separating the barrier fluid from the lubricant in the motor compartment, and a pump seal 19, separating the barrier fluid from seawater in the pump. The seals 18 and 19 may be realized as mechanical seals.

The barrier fluid chamber 20 is supplied fluid, in this case treated seawater, which is extracted from the seawater flow discharged from the pump. Seawater is extracted downstream of a water treatment unit 21 arranged in the discharged seawater flow, and injected into the barrier fluid chamber via a pressure regulator or pump 22 and a barrier fluid feed line 23.

The water treatment unit 21 is a microfiltration unit containing a finely pored membrane effective for separating suspended particles and salts from the seawater. The water treatment unit 21 may be a unit for water treatment by osmosis, or a reverse osmosis device, capable of discharging desalinated water as process water for further processing downstream.

The pump 22 is a device operable for controlling the pressure in the extraction water to above the pressure of the seawater in the pump 3. To this purpose, e.g., the pressure in the discharged seawater downstream of the pump 3 may be detected and transmitted to the pump 22, in the drawing illustrated through the dashed line 24. The pump 22 may in this way be controlled to feed extraction water at a pressure of about 2-10 bar above the pump discharge pressure, or above the pressure in seawater discharged from the pump.

Excessive water may be allowed to migrate from the barrier fluid chamber 20 into the pump. However, in order to avoid contamination of a water treatment unit 21 in the event of lubricant migrating into the barrier water, excessive barrier water is returned outside the pump to the seawater flow downstream of the water treatment or reverse osmosis device 21, via barrier fluid return line 25 arranged for return and reinjection of barrier fluid downstream of the point of extraction. This way, the osmosis unit is protected from contamination by lubricant eventually migrating into the barrier fluid chamber 20 via the motor seal 18.

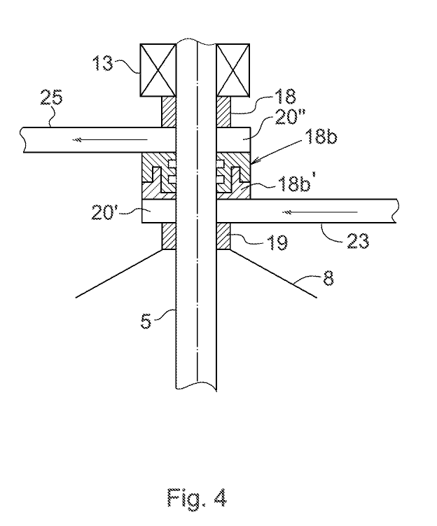

In one embodiment a labyrinth seal 18b is arranged between the motor seal 18 and the pump seal 19 in the barrier fluid chamber 20 to seal about the motor or pump shaft 4 or 5. This embodiment is illustrated schematically in FIG. 4. Labyrinth seals are known by persons skilled in the art. A labyrinth seal which has a portion 18b′ that rotates with the shaft, e.g., is configured to prevent flow over the seal in one direction at least. In effect of its internal structure the rotating labyrinth seal creates a kind of pressure barrier between the motor seal 18 and the pump seal 19, permitting one-way flow of barrier fluid/extraction water over the labyrinth seal 18b from the barrier fluid feed line 23 to the barrier fluid return line 25. The labyrinth seal 18b thus divides the barrier fluid chamber 20 into an inlet sub chamber 20′ facing towards the pump, and an outlet sub chamber 20″ facing towards the motor.

For purpose of cooling and/or lubrication, extraction water may additionally be supplied to the rotor shaft bearing 14 in the non-driven end of the pump, via an extraction water supply line 26 which is branched off from the barrier fluid feed line 23. Excessive water can be allowed to flush the bearing and migrate into the seawater in the pump without risking damage to the osmosis water treatment unit 21.

The lubricant contained in the pressure vessel 15 may be a mixture of water and ethylene glycol. To this purpose glycol is supplied to the pressure vessel 15 from a glycol supply tank 27, or directly from topside via supply line 28 or via an umbilical. Glycol is introduced in the pressure vessel via pressure regulator 29 and supply line 30. The pressure in the glycol supply tank 27 may be maintained through a seawater connection at the pump discharge. A membrane inside the glycol supply tank divides the glycol from the seawater.

The pressure regulator 29 is a device operable for raising the pressure in the glycol to above the pressure of the pump discharge pressure. To this purpose, e.g., the pressure in the discharged seawater downstream of the pump may be detected and transmitted to the pressure regulator 29, in the drawing illustrated through the dashed line 31. The pressure regulator 29 may in this way be controlled to discharge the glycol at a pressure of about 10-30 bar above the pump discharge pressure. Further, the pressure in the motor compartment 7 may be regulated to be at least about 10 bar above discharge pressure downstream the water treatment 21 by means of the pressure regulator 29.

Water for mixing with the glycol is extracted from the seawater flow that is discharged from the pump. Thus for mixing purpose, treated seawater is extracted from the seawater flow downstream of the water treatment unit 21 and supplied via supply line 32 and a pump 33 which is operable for injecting the extraction water into the glycol.

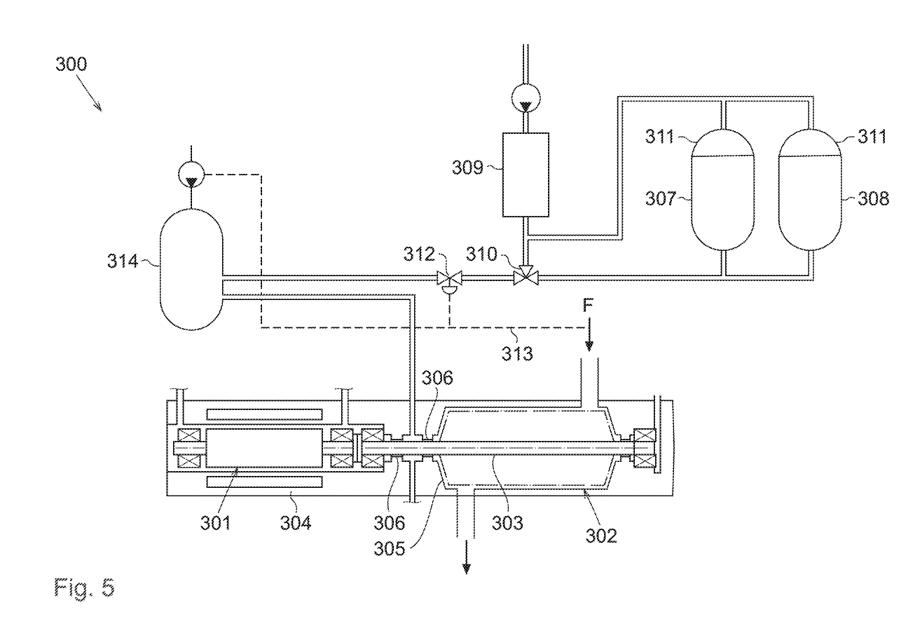

FIG. 5 shows an alternative implementation of the invention in a subsea boosting station 300. The boosting station includes a motor 301 and a pump 302. The motor is drivingly connected to the pump via a shaft 303 that passes from a motor compartment 304 into a pump chamber 305 via a seal arrangement 306. The pump is installed in a fluid flow F and operated for boosting the pressure in fluid that passes through the pump as illustrated by arrows. The boosting station 300 comprises glycol tanks 307, 308 and a reverse osmosis device 309 by which fresh water/desalinated water is produced from seawater. Due to low barrier fluid consumption in the seal arrangement the glycol tank can be dimensioned to be retrieved every 2-4 years. The ratio of water to glycol can typically be set to 40-60%, however other values can be applied. The water/glycol ratio is set by a three way valve 310. The pressure of glycol is equalized to the discharge pressure from the reverse osmosis device via a membrane 311 which is installed in the glycol tank(s) and biased by the pressure in water discharged from the reverse osmosis device 309. The pressure in the osmosis device and system is typically higher than the pressure in lubricant/cooling fluid in the motor and motor compartment. Pressure in the motor is regulated by a pressure control valve 312 which is referenced to the pump inlet pressure, transmitted via line 313. The water/glycol mixture is supplied to an expansion tank 314 which is maintained at a pressure that is about 25 bar above the pressure in the pump.

The water/glycol mixture that is accumulated in the expansion tank 314 ensures the pressurized storage of barrier/lubrication fluid for the motor in transient operation modes, startup and shutdown conditions.

The embodiments disclosed provide a hydrocarbon free seawater injection system, allows simplification without active controls and uses seawater as barrier fluid. No topside barrier fluid hydraulic power unit (BF HPU) required, reduced platform weight and umbilical cost are other benefits achievable by the presented system and method.

A method and system for producing high quality water for use in a process of subsea water treatment are in this way provided, featuring the characteristics recited in the appended claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for supplying barrier fluid in a subsea motor and pump assembly, comprising:
extracting desalinated water from a reverse osmosis device, and
supplying the extracted desalinated water to the subsea motor and pump assembly, either alone or as mixture with ethylene glycol.

2. The method of claim 1 comprising:
providing a volume of glycol in a glycol tank arranged subsea, desalinating seawater by passing seawater through a reverse osmosis device arranged subsea,
mixing glycol with desalinated seawater to create a water/glycol mixture, and
feeding the water/glycol mixture as barrier/lubrication fluid to the subsea motors and pump assembly.

3. The method of claim 2, comprising feeding the discharge pressure from the reverse osmosis device to a membrane installed in the glycol tank to set the pressure in glycol equal to the discharge pressure from the reverse osmosis device.

4. The method of claim 3, comprising regulating the discharge pressure from the reverse osmosis device to in the order of approximately 10-30 bar, preferably approximately 20, bar above the pump pressure.

5. The method of claim 3, comprising mixing water with glycol in a three way valve and feeding the mixed fluid to an expansion tank.

6. The method of claim 5, comprising monitoring of the inlet pressure to the pump and setting the pressure in the expansion tank to in the order of approximately 10-30 bar above the pump inlet pressure.

7. The method of claim 1, comprising mixing water with glycol to a ratio of water to glycol in the order of 40-60%.

8. A method according to claim 1 for supplying barrier fluid in a subsea motor and pump assembly for producing process water from seawater, wherein a motor in a motor compartment is drivingly connected to a pump rotor in a pump housing, a shaft between them transmitting the motion of the motor to the pump rotor, the method comprising:
operating the pump for boosting the pressure in seawater discharged from the pump,
passing the seawater through a reverse osmosis device for desalination,
extracting desalinated water from the reverse osmosis device or from a process water flow downstream of the reverse osmosis device,
raising the pressure in the extracted water to above the internal pressure in the pump, and feeding the pressurized extraction water to the subsea motor and pump assembly for cooling and/or lubrication and/or barrier purposes.

9. The method of claim 8, wherein extraction water is supplied as barrier fluid to a barrier fluid chamber.

10. The method of claim 9, wherein extraction water from the barrier fluid chamber is returned to the desalinated water flow downstream of the reverse osmosis device.

11. The method of claim 1, comprising supplying extraction water through a pump rotor shaft bearing in the non-driven end of the pump rotor.

12. The method of claim 1, comprising mixing desalinated extraction water with ethylene glycol to produce lubricant and/or motor cooling fluid.

13. The method of claim 12, comprising raising the pressure in the water/glycol mixture to above the pressure in the barrier fluid chamber, and bleeding water/glycol mixture into the barrier fluid chamber via the motor seal.

14. (canceled)

15. A system for supplying barrier fluid in a subsea motor and pump assembly arranged for producing process water from seawater, the system comprising a subsea motor and pump assembly arranged in a seawater flow for boosting the pressure in seawater which is passed through a reverse osmosis device for desalination, wherein desalinated water is extracted from or downstream of the reverse osmosis device and communicated to the subsea motor and pump assembly via a barrier fluid feed line and a pump or accumulator that raises the pressure in the extracted water to above the internal pressure in the pump.

16. The system of claim 15 wherein a motor in a motor compartment is drivingly connected to a pump rotor in a pump chamber, wherein a shaft transmits the motion of the motor to the pump rotor, the motor and pump assembly further comprising:
a motor seal and a pump seal sealing about the shaft, the pump and motor seals axially separated on the shaft the motor seal and the pump seal defining between them a barrier fluid chamber which is separated from lubricant fluid on the remote side of the motor seal, and separated from seawater on the remote side of the pump seal, wherein the barrier fluid feed line is arranged to feed desalinated water to the barrier fluid chamber.

17. The system of claim 16, wherein a barrier fluid return line connects the barrier fluid chamber with the flow of desalinated water downstream of the reverse osmosis device.

18. The system according to claim 16, wherein a pump rotor shaft bearing in the non-driven end of the pump rotor is supplied desalinated water extracted from or downstream of the reverse osmosis device.

19. The system according to claim 16, wherein a labyrinth seal is arranged between the motor seal and the pump seal.

20. The system of claim 16 comprising:
a subsea tank holding a volume of glycol,
a reverse osmosis device arranged subsea,
a three way valve controllable for mixing desalinated water from the reverse osmosis device with glycol from the glycol tank, and
feed lines to supply the water/glycol mixture as barrier/lubrication fluid to the subsea motor and pump assembly.

21. The system of claim 20, wherein a membrane setting the pressure in glycol in the glycol tank is subjected to the discharge pressure from the reverse osmosis device.

22. (canceled)

23. (canceled)

24. (canceled)
